(19) United States
(12) Patent Application Publication
(10) Pub. No.: US 2025/0319656 A1
(43) Pub. Date: Oct. 16, 2025

(54) FOAMING, DUAL-CURING, AND ADDITIVE MANUFACTURING METHOD AND ADDITIVE MANUFACTURED RESIN ELASTOMER OBTAINED THEREFROM

(71) Applicant: TPK Material Solutions ( Xiamen ) Inc., Xiamen(area A) (CN)

(72) Inventors: Ya Wan Chen, Hsinchu County (TW); Yu Li, Herbei Province (CN); Chin Hui Lee, Taipei City (TW)

(21) Appl. No.: 19/175,005

(22) Filed: Apr. 10, 2025

(30) Foreign Application Priority Data
Apr. 11, 2024 (CN) 202410436921.6

(51) Int. Cl. B29C 64/165; B29C 64/188; B29C 64/264; B29K 105/04; B33Y 10/00; B33Y 70/10; B33Y 80/00

(52) U.S. Cl. CPC B29C 64/165; B29C 64/188; B29C 64/264; B29K 2105/046; B29K 2995/0012; B33Y 10/00; B33Y 70/10; B33Y 80/00

(57) ABSTRACT

The present disclosure provides a method of additive manufacturing foamed dual-curing resin and the additive manufactured resin elastomer formed therefrom. The method includes the following operations. Resin providing process: a foaming dual-cure resin composition suitable for additive manufacturing in continuous liquid interface production is provided. Additive manufacturing process: the foaming dual-curing resin composition is placed in a printer for continuous liquid interface production, and a digital UV light source is used to irradiate the foaming dual-curing resin composition, such that a portion of the foamed dual-curing resin composition that is irradiated photopolymerizes to form a grid structure, which is an intermediate object having a three-dimensional grid. Foaming process: the intermediate object having the three-dimensional network is placed in a thermal environment to perform foaming, and the intermediate object is thermally cured to further enhance the mechanical properties, thereby forming the additive manufactured resin elastomer.

### CROSS-REFERENCE TO RELATED APPLICATIONS

This application claims priority to China Patent Application 202410436921.6, filed on Apr. 11, 2024, which is incorporated herein by reference.

### FIELD OF DISCLOSURE

The present disclosure relates to a foaming, dual-curing, and additive manufacturing method and additive manufactured resin elastomers obtained thereby, especially a foaming, dual-curing, and additive manufacturing method applied in the continuous liquid interface production (CLIP) of three-dimensional (3D) printing technology and the additive manufactured resin elastomers obtained thereby.

### DESCRIPTION OF RELATED ART

The continuous liquid interface production (CLIP) of three-dimensional (3D) printing technology projects ultraviolet (UV) light through a transparent bottom of a resin tank, curing the portion exposed to UV light, and forming three-dimensional structures through crosslinking polymerization. Next, the three-dimensional structure is heated to restructure and decompose blocked polyurethanes (BPUR), a component of the foaming dual-curing resin composition, achieving completely thermal curing. Finally, a final product is produced. The aforementioned continuous liquid interface production (CLIP) technology is disclosed on the webpages of Carbon3D, Inc. https://www.carbon3d.com/carbon-dls-technology. Although the continuous liquid interface production technology allows for the manufacturing of more exquisite and elaborate structures, comparing to conventional layer-by-layer 3D printing, the requirement of placing the liquid form of foaming dual-curing resin composition in the resin tank limits the size of the printed products. Therefore, Carbon3D, Inc. has developed a foaming resin composition that initially uses CLIP technology to print a smaller three-dimensional structure. The structure is then subject to curing and a foaming reaction through a heating process. As a result, the final product that is produced overcomes the size constrains by the resin tank built into the CLIP printing machine.

The foaming resin composition developed by Carbon3D, Inc. incorporates microcapsules that are foamed by physical method. This foaming dual-curing resin composition is produced by mixing a dual-curing resin composition as the matrix resin and foaming particles (i.e. microcapsules) feature a hollow sphere structure with a shell made of thermoplastic resin, enclosing a lower carbon alkane-based compound. When the foaming dual-curing resin composition is printed in the CLIP printing machine, the microcapsules, along with the base resin, are irradiated by UV light. As the matrix resin forms a three-dimensional structure through crosslinking polymerization upon UV exposure, the microcapsules mixed therein are embedded in the substantial part of the three-dimensional structure. Upon heating, microcapsules expand their volume through the gasification of an enclosed lower carbon alkane-compound; simultaneously, their thermoplastic shells soften, become extendable and enlarge, yet continues to enclose the gasified alkane content. Compared to the well-studied chemical foaming technology, the method of the present disclosure is much more environmentally friendly. Additionally, it does not require expensive equipment and poses no safety hazards, unlike supercritical fluid, or other physical foaming technologies.

US patent number U.S. Ser. No. 11/292,186B2, held by Carbon3D, Inc. discloses an additive manufacturing technology using the foamable resin composition to produce a low-density three-dimensional object. However, it does not explore how to manage achieving an evenly-foamed final product when heat-expandable microsphere are added to the dual cure resin. Another patent publication WO2023078844A1 discloses a midsole with a dual shock-absorbing effect provided by foaming materials and a three-dimensional network structure. The technological method achieves the buffering effect through the solid geometric configurations of the three-dimensional network and the foaming rate of the foaming agent. However, it does not specify the foaming process, nor does it address the uniformity of foaming. Therefore, the additive manufacturing process for creating a resin elastomer with a three-dimensional network structure, where the substantial part of the network possesses foaming material characteristics, has not been clearly explained. Specifically, ensuring that the three-dimensional network remains intact after the foaming process is completed remains inadequately addressed.

### SUMMARY OF THE DISCLOSURE

The present disclosure provides additive manufacturing method of a foaming dual-curing resin. The method comprises the following operations. Resin providing process: providing the foaming dual-curing resin composition suitable for additive manufacturing in continuous liquid interface production, the foaming dual-curing resin composition comprising a matrix resins and heat-expandable microcapsules. Additive manufacturing process: placing the foaming dual-curing resin composition in a printer for continuous liquid interface production, and subjecting the foaming dual-curing resin composition to ultraviolet (UV) radiation to irradiate foaming dual-curing resin composition, causing the irradiated portion of the foaming dual-curing resin composition to photopolymerize and form a grid structure, which constitutes a plurality of mesh structures that construct a three-dimensional network, constituting an intermediate object; simultaneously, the heat-expandable microcapsules within the foaming dual-curing resin composition are embedded in the substantial part of the mesh structure of the intermediate object through the photopolymerization reaction of the matrix resins. Foaming process: removing the intermediate object is transferred from the continuous liquid interface production printer and placing the intermediate object in a hot environment to allow the heat-expandable microcapsules embedded in the substantial part of the mesh structure to be heated and expand. Thus, the three-dimensional network of the intermediate object enlarges due to the expansion of the heat-expandable microcapsules, causing the overall volume of the printed intermediate object to fully expand as the foams reach their ultimate size. Simultaneously, the intermediate object completes thermal curing in the hot environment, ultimately resulting in an additive-manufactured resin elastomer. In some embodiments, the mesh structure comprises a substantial part and spaces surrounded by the material part.

In some embodiments, the resin providing process involves providing a foaming dual-curing resin composition that has alleviated sedimentation according to Stokes' law. For example, the dual-curing resin composition may feature a minimal density difference between the heat-expandable microcapsules and the matrix resin, adequate viscosity of the matrix resin, and an appropriate particle size. The aforementioned Stokes' law is:

$$Vg = \frac{{d}^{2} * ( Δρ ) * g}{18 * η} .$$

In some embodiments, the density difference between the matrix resin and the heat-expandable microcapsules in the foaming dual-curing resin composition less than 1 g/mL, but equal to or larger than 0 g/mL.

In some embodiments, the heat-expandable microcapsules are non-reactive to UV irradiation during the additive manufacturing process.

In some embodiments, the foaming process comprises a temperature-rising phase and a temperature-holding phase. The temperature-rising phase involves increasing the temperature from room temperature to between 90° C. and 220° C. at a rate of 1° C. to 3.5° C. per minute. The temperature-holding phase then maintains the final temperature achieved at the end of the temperature-rising phase for 1 to 5 hours.

In some embodiments, the foaming process involves sequentially conducting the following phases: a first temperature-rising phase, a first temperature-holding phase, a second temperature-rising phase, and a second temperature-holding phase. The first temperature-rising phase involves raising the temperature from room temperature to a first temperature between 100° C. and 120° C. over a period of 0.75 to 1.25 hours. The first temperature-holding phase then maintains heating at the first temperature for 3.5 hours to 4.5 hours. The second temperature-rising phase increases the temperature from the first temperature to a second temperature of 130° C. to 150° C. over 20 to 40 minutes. Upon reaching the second temperature, the process transitions to the second temperature-holding phase, which involves maintaining the second temperature for 5 minutes to 15 minutes.

In some embodiments, the foaming process is performed at standard atmosphere.

In some embodiments, the foaming process involves further polymer bonding within the polymer network of the intermediate object, which is formed by UV polymerization. This further polymer bonding, induced by thermal effects of the foaming process, strengthens the mechanical performance of the polymer network.

The present disclosure also provides an additive-manufactured resin elastomer produced by the aforementioned additive manufacturing method using foaming dual-curing resin. This elastomer features an additive manufactured three-dimensional network constructed from interconnected mesh structures. Each mesh structure comprises a spatial arrangement of basic geometric configurations, formed by the substantial part of the three-dimensional network, which construct the additive-manufactured resin elastomer. The substantial part of the additive-manufactured resin elastomer contains multiple voids resulting from the foaming process, which culminate in the absolute value of density gradient of the first, second, and third directions—each perpendicular to the others—being less than 50 kg/(m³*cm) respectively.

In some embodiments, each of the voids resulting from the foaming process has a closed-cell structure.

In some embodiments, the voids resulting from the foaming process increase the volume of the additive-manufactured resin elastomer by 100% to 350% compared to its original volume before foaming.

### BRIEF DESCRIPTION OF THE DRAWINGS

To better understand the novel features, contents, and advantages of the present disclosure, detailed descriptions of the present disclosure are provided as follows, accompanied by diagrams and preferred embodiments. According to the industrial standard approach, the features and dimensions displayed in the diagrams and exemplary embodiments may be enlarged, simplified, or generalized in descriptions without necessarily implying the actual size, ratio, and precise configurations of each element. Furthermore, for the purpose of simplifying drawings, some structures and components of the prior art shown in the drawings would be illustrated schematically.

FIG. 1 is a flowchart of the method for foaming dual curing resin additive manufacturing according to some embodiments disclosed in the present disclosure.

FIG. 2 is a schematic diagram of the UV exposure procedure according to some embodiments disclosed herein, where the resin tank in the continuous liquid interface production printer is subjected to UV irradiation, causing the matrix resin in the resin tank to undergo photopolymerization reactions to form an intermediate object.

FIG. 3 is schematic diagram of the UV irradiation step according to some embodiments disclosed herein, where the resin tank in the continuous liquid interface production printer is subjected to UV irradiation, causing the matrix resin in the resin tank to undergo photopolymerization and form an intermediate object;

FIG. 3 is presented as a black and white photograph and corresponds to an enlarged schematic of the dashed box in FIG. 2.

FIG. 4A and FIG. 4B are photographs showing some embodiments disclosed herein, showing the thermal curing of the matrix resin of the intermediate object in the foaming process and the expansion of the volume of the thermal expansion capsules within the matrix resin as well.

FIG. 5A and FIG. 5B are schematic diagrams according to some embodiments disclosed herein, illustrating the thermal curing of the matrix resin of the intermediate object in the foaming process and the expansion of the volume of the thermal expansion capsules within the matrix resin as well.

FIG. 6 is a photograph of the additive manufactured resin elastomers formed according to some embodiments disclosed herein. The left side of the photograph shows the additive manufactured resin elastomer obtained from foaming dual-curing resin through additive manufacturing, and the right side of the photograph shows the additive manufactured resin obtained from non-foaming dual-curing resin through additive manufacturing.

FIG. 7 is a photograph showing the results of properly and improperly controlled foaming processes in the production of additive manufactured resin elastomers foamed according to some embodiments disclosed herein. The left side of the photograph shows the result of a foaming process was not properly controlled, leading to excessive expansion and damage to the three-dimensional network. The right side of the photograph shows a successfully controlled process, resulting in an intact resin elastomer obtained from foaming dual-curing resin produced through additive manufacturing.

FIG. 8 is a schematic diagram of an additive manufactured resin elastomer formed according to some embodiments disclosed herein, where the additive manufactured resin elastomer comprises a plurality of parts distributed continuously from one side to the opposite side.

FIG. 9 is a diagram showing the average density variations for different parts of the additive manufactured resin elastomer, as per some embodiments disclosed herein. Each bar represents a distinct section of the elastomer, showing the density profile form one side to the opposite side.

### DETAILED DESCRIPTION OF THE PREFERRED EMBODIMENTS

To better describe and explain more completely the present disclosure, various forms and comprehensive descriptions of embodiments are provided as follows. Embodiments of the present disclosure are not limited to one form, and the embodiments may be combined or substituted under beneficial circumstances. Without further explanations, other embodiments may be included in the contents of the present disclosure.

Relative terms in space, for example, above and below, in the present disclosure are for describing the relative relation in space of an element with respect to another element. In addition to the direction illustrated in the figures, relative terms in space intend to describe different directions while the device is in operation. For example, the device can be driven to a direction (such as rotated by 90 degrees or other directions). Therefore, relative terms in space used in the present disclosure can also be expressed accordingly. In the present disclosure, unless otherwise indicated, the same component numbers in different figures mean identical or similar components using the same or similar materials made by the same or similar methods.

The terms “about,” “near,” “close,” “basically,” or “essentially” used in the present disclosure include values and characteristics and deviations in value and characteristics that can be easily completed by a person having ordinary skill in the art. For example, in consideration of deviations of the values and characteristics, these terms are used to express values of one or multiple standard deviations of the value (for example, values within ±30%, ±20%, ±15%, ±10% or ±5%); or to express the deviation of the described character in operation (for example, the description of “in parallel essentially” means a condition close to one in parallel essentially, yet not in a perfect parallel).

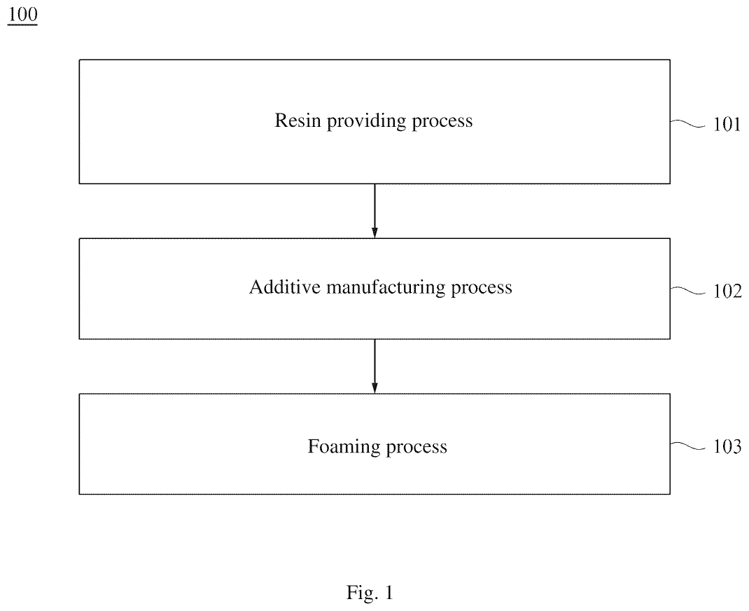

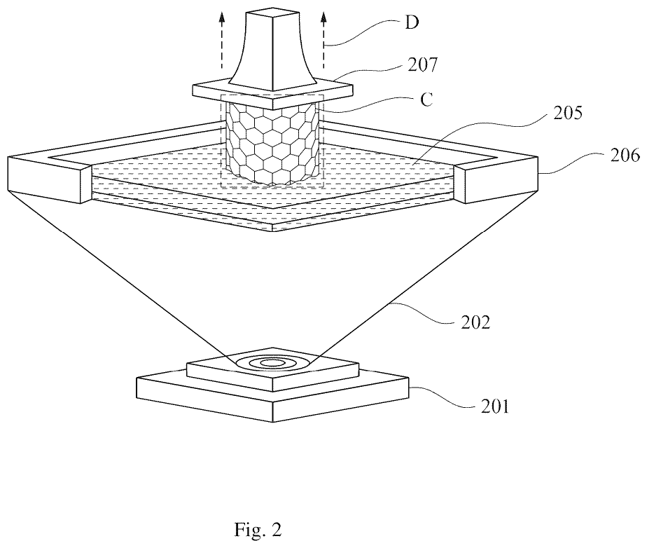

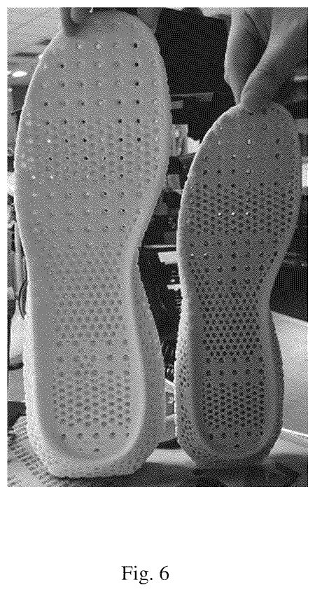

The present disclosure provides a method for foaming dual-curing resin additive manufacturing, as method 100 shown in FIG. 1. Please also refer to FIG. 2 to FIG. 9 while reviewing method 100 of FIG. 1. More specifically, method 100 comprises steps 101 to 103. Step 101: resin providing process, comprising providing a foaming dual-curing resin composition suitable for additive manufacturing in continuous liquid interface production (CLIP) is provided. For example, the foaming dual-curing resin composition can be one or more of products offered by Carbon3D, Inc. or TPK Electronic Materials Co., Ltd. (for example, foaming resin composition disclosed in the patent application U.S. Ser. No. 19/098,094 entitled “Foamable resin composition” submitted by TPK Electronic Materials Co., Ltd.), or could be a combination of commercially available non-foaming dual-curing resin compositions and heat-expandable microcapsules mixed together. The density difference between the selected non-foaming dual-curing resin and the heat-expandable microcapsule is less than 1 g/mL. The aforementioned foaming dual-curing resin composition can achieve a significantly larger volume though the method disclosed herein, forming the additive manufactured resin elastomer (shown in FIG. 6, left), compared to the volume of a non-foaming dual-curing resin composition (shown in FIG. 6, right). Step 102: additive manufacturing process, which involves pouring the liquid foaming dual-curing resin composition from the resin providing process of Step 101 into the resin tank of the CLIP printer. The process then irradiated the resin composition with a digital ultraviolet (UV) light source, causing the resin, where the resin is subjected to the UV irradiation, to photopolymerize and define a grid structure, thereby forming an intermediate object with a three-dimensional network. The heat-expandable microcapsules mixed in the resin composition are embedded in the substantial part of the mesh structure of the intermediate object during the UV irradiation, without reacting to the UV light. Step 103: foaming process, which involves the thermal expansion of the microcapsules embedded in the substantial part of the three-dimensional structure of the intermediate object, and concurrent strengthening of the grid structure, formed in Step 102, due to the application of heat. The additive manufactured resin elastomer can achieve a higher volume expansion ratio after Step 103, and the foaming process does not damage the grid structure produced in Step 102. In other words, the mesh structure of the additive manufactured resin elastomer remains intact, and the substantial structure formed by the cured resin composition maintains the same basic geometric spatial arrangement as the corresponding mesh structure of the intermediate object before heating. Furthermore, Step 103 allows the substantial structures formed by the resin composition to undergo further thermal curing after UV irradiation polymerization in Step 102, thus significantly improving the mechanical properties of the additive manufactured resin elastomer, such as, improved compressive strength, torsional rigidity, shear strength, impact resistance, tensile strength, elongation at break, and (pants-shaped) tearing strength. The details of method 100 are further explained according to the embodiments.

In Step 101, when the resin providing process involves the use of commercially available foaming dual-curing resin composition, because the foaming dual-curing resin composition includes a liquid matrix resin and heat-expandable microcapsules suspended within the liquid matrix resin, the foaming dual-curing resin composition should be stirred before being poured into the resin tank to ensure the microcapsules are evenly distributed throughout the liquid resin composition. This is because, although commercially available foaming dual-curing resin compositions are formulated with consideration for shelf life and storage conditions before leaving the factory, prolonged storage can still lead to the heat-expandable microcapsules settling downwards or rising due to long periods of inactivity, resulting in an uneven distribution of the microcapsules within the liquid matrix resin. The stirring should be sufficient to evenly suspend the heat-expandable microcapsules within the liquid matrix resin, without being overly vigorous to avoid increasing the overall viscosity due to fluid shear thickening effect, which could affect the printing quality in the additive manufacturing process of Step 102. In Step 101, when the resin supply process involves separately purchasing commercially available non-foaming dual-curing resin composition and heat-expandable microcapsules, and mixing the two, in addition to selecting heat-expandable microcapsules with a density close to the density of the matrix resin, it is also advisable to choose heat-expandable microcapsules products with a more uniform particle size distribution (PSD). Furthermore, when separately purchasing the matrix resin and heat-expandable microcapsules for combined use, before mixing the two, the fine particles of heat-expandable microcapsules should firstly be wetted with a small amount of photopolymerizable monomers, and then added to the matrix resin. This is to prevent dry heat-expandable microcapsules particles from clumping together during the addition to the liquid matrix resin, making it difficult to disperse the dry heat-expandable microcapsules particles evenly throughout the base resin. The photopolymerizable monomers can be as disclosed in the aforementioned patent application U.S. Ser. No. 19/098,094 entitled “Foamable resin composition” or it can be any other monomers that participate in UV photopolymerization.

Continuing the explanation for Step 101, the foaming dual-curing resin composition 205 comprises a matrix resin and heat-expandable microcapsules. The matrix resin composition may include urethane (meth) acrylate oligomer and photoinitiators, such as the resin products EPU40, EPU41, EPU44, EPU46, etc., produced by Carbon3D, Inc. The chemical compositions are disclosed in their patent documents and other literature cited therein, for example U.S. Ser. No. 10/471,655, U.S. Ser. No. 10/259,171, U.S. Ser. No. 10/975,193, U.S. Ser. No. 10/350,823, etc. The difference in density between the matrix resin and the heat-expandable microcapsule is less than 1 g/mL and greater than or equal to 0 g/mL, preferably the difference is less than 0.5 g/mL, more preferably less than 0.3 g/mL. When the density difference between the matrix resin and the heat-expandable microcapsule falls within the aforementioned ranges, it prevents significant settling difference between the matrix resin and the heat-expandable microcapsules in the foaming dual-curing resin composition 205. Consequently, when proceeding with the additive manufacturing process in Step 102, this allows for a uniform distribution of the heat-expandable microcapsules embedded within the substantial part of the mesh structure. Therefore, in the subsequent Step 103, these uniformly distributed heat-expandable microcapsules can achieve a uniform expansion effect in all dimensions after foaming, that is, roughly equal expansion effects in X-Y-Z directions. This ensures that the final additive manufactured resin elastomer achieves the desired uniformity in density and density variations. In some embodiments, the densities of the matrix resin and the heat-expandable microcapsule are independently from 0.4 g/mL to 1.8 g/mL, for example, 0.4 g/mL, 0.8 g/mL, 1.0 g/mL, 1.1 g/mL, 1.2 g/mL, 1.5 g/mL, or 1.8 g/mL.

Continuing the explanation for Step 101. In some embodiments, the particle size of the heat-expandable microcapsule is preferably from 10 μm to 30 μm, for example, 10 μm, 15 μm, 20 μm, 25 μm, or 30 μm, in order to prevent the heat-expandable microcapsules from settling too quickly or slowly in the foaming dual-curing resin composition 205. This helps to improve the uniform distribution of the heat-expandable microcapsules within the foaming dual-curing resin composition 205. In some embodiments, the viscosity of the foaming dual-curing resin composition 205 at about 25° C. measured by the viscometer is preferably from 100 cP to 10000 cP, for example, 100 cP, 500 cP, 1000 cP, 3000 cP, 4000 cP, 5000 cP, 5500 cP, 6000 cP, 7000 cP, 8000 cP or 10000 cP, with the more preferable range being from 100 cP to 5500 cP to avoid the heat-expandable microcapsules settling too quickly or too slowly in the foaming dual-curing resin composition 205. This also helps to improve the uniform distribution of the heat-expandable microcapsules within the foaming dual-curing resin composition 205.

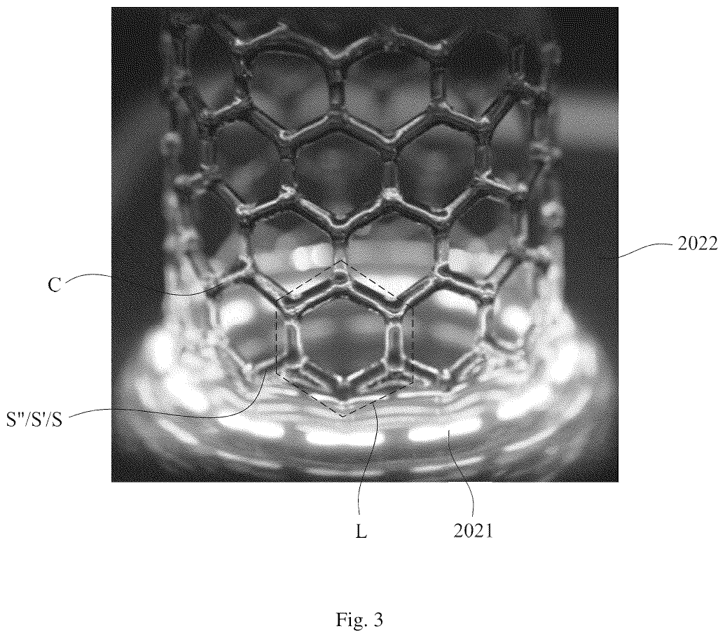

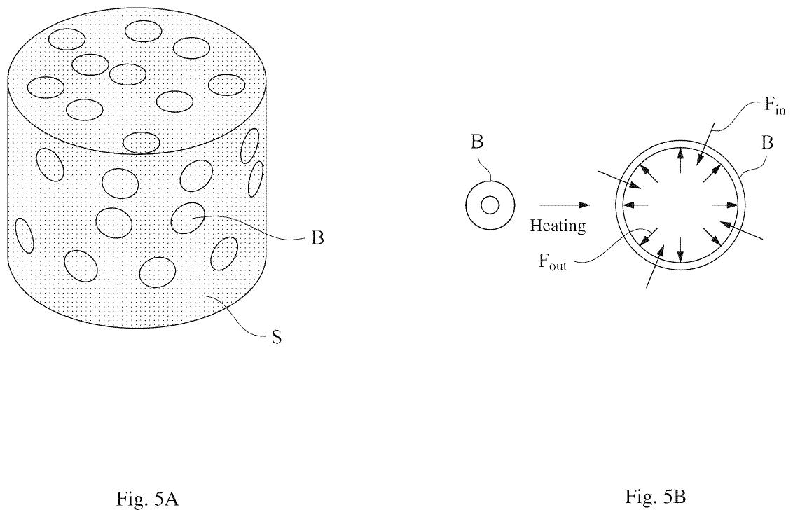

In step 102, the digital UV light source 201 focuses within the digital UV irradiation range 202 on the area where crosslinking reactions are intended to occur, irradiating the liquid foaming dual-curing resin composition 205 in the resin tank 206, causing the matrix resin therein to undergo the crosslinking reactions and form an intermediate object C. The digital UV light source 201 can convert digital signals into a focused light area, with a corresponding pattern through a device based on digital light processing (DLP) technology (not shown in the figures), allowing the foaming dual-curing resin composition 205 exposed to the UV light from digital UV light source 201 to be polymerized into the desired three-dimensional structure as needed. The devices using digital light processing technology can be the 3D printer produced by Carbon3D, Inc., for example, the Carbon 3D printer, including various models like M1, M2, M3, L1, or other printers designed based on the same or similar principles from different manufacturers. In more detail, a digital UV light source 201 is positioned below the resin tank 206, which has a transparent bottom, allowing the light emitted from the digital UV light source 201 to irradiate the foaming dual-curing resin composition 205 contained within the resin tank 206. The light from the digital UV light source 201 is focused on the specific parts within the resin tank 206 according to the digitally specified irradiation area and timing, causing the matrix resin in the digital UV focused irradiation area 2021 to photopolymerize from an original liquid state into a solid state due to the absorption of UV irradiation energy. The areas that are not subjected to focused irradiation from the digital UV light source 201 are called the digital UV non-focused irradiation area 2022. Since the foaming dual-curing resin composition 205 comprises a liquid matrix resin and evenly suspended heat-expendable microcapsules, and the heat-expendable microcapsules do not react to UV irradiation, when the liquid matrix resin solidifies due to UV radiation, the originally mixed-in heat-expendable microcapsules B become embedded in the cured matrix resin, as shown in FIG. 5A. As the foaming dual-curing resin composition 205 in the resin tank 206 is additively manufactured into an intermediate object C with a three-dimensional network on the aforementioned 3D printer, the matrix resin of the foaming dual-curing resin composition 205 forms the substantial part S of the mesh structure L in the three-dimensional network, while the heat-expendable microcapsules within the foaming dual-curing resin composition 205 remain in an original state embedded in the substantial part S of the mesh structure L (not shown in FIG. 3).

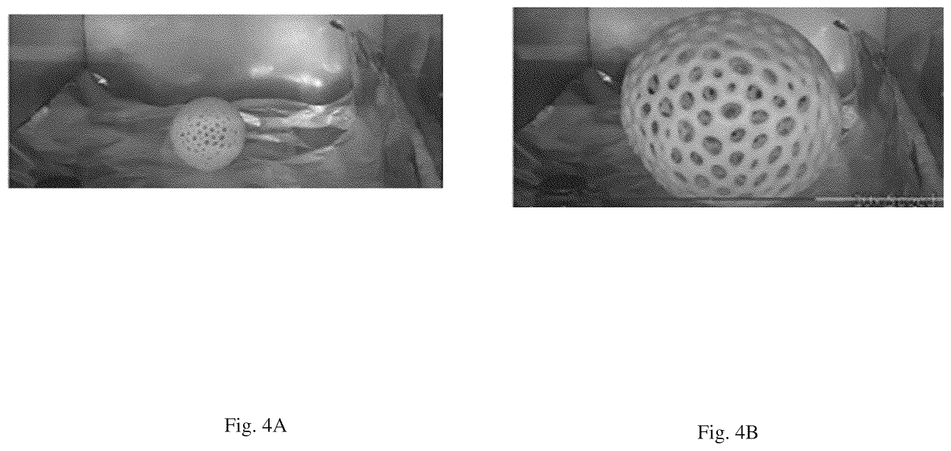

Continuing the explanation of Step 102. In some embodiments, the digital UV focused irradiation area 2021 is located near the bottom of the resin tank 206. More specifically, the digital UV light source 201 is focused on a plane parallel to the bottom surface of the resin tank 206, which means that the digital UV focused irradiation area 2021 is entirely on the same plane. For example, the digital UV light source 201 focuses on a plane parallel to the bottom of the resin tank 206 to form the desired patterned digital UV focused irradiation area 2021, as shown in FIG. 3. In some embodiments, after the foaming dual-curing resin composition 205 is poured in the resin tank 206, the carrier platform 207 is positioned close to the bottom of the resin tank 206. The digital UV light source 201 is focused on the plane of the carrier platform 207 that faces the resin tank 206. By projecting a desired patterned digital UV focused irradiation area 2021 onto this plane, the substantial part S′ of the mesh structure L is formed on the carrier platform 207. Since the digital UV light source 201 focuses only on one plane, once the substantial parts S′ are formed on the plane of the carrier platform 207 that faces the bottom of the resin tank 206, the 3D printer adheres to the present printing procedure by moving the carrier platform 207 in the pulling direction D. This movement causes the photopolymerized substantial parts S′ to shift away from the original focused plane. Subsequently, the digital UV light source 201 emits focused UV light again according to the digital signals, foaming new substantial parts S″ in the direction opposite to the pulling direction D on the substantial parts S′. The substantial parts S′ formed before the carrier platform 207 is pulled up, and the new substantial parts S″ formed after the carrier platform 207 is pulled up, are both formed by the irradiation of the liquid foaming dual-curing resin composition 205, thus before and after pulled up, the new addition is continuous and without obvious boundaries. Moreover, since the foaming dual-curing resin composition 205 comprises the matrix resin and the heat-expandable microcapsules, and the heat-expandable microcapsules are evenly suspended within the matrix resin, when the foaming dual-curing resin composition 205 undergoes photopolymerization due to focused UV irradiation, the originally evenly suspended heat-expandable microcapsules are embedded within the substantial part S formed by the polymerization of the matrix resin. In other words, after the formation of intermediate object C, the heat-expandable microcapsules are evenly dispersed in the substantial parts S of the mash structures in the three-dimensional network. These heat-expandable microcapsules evenly distributed in the substantial parts S of the mash structures in the three-dimensional network remain in their original state. The aforementioned original state means that these heat-expandable microcapsules remain unchanged from their original state before Step 102 was carried out; in other words, the heat-expandable microcapsules do not change during Step 102, especially they do not undergo thermal expansion. After the intermediate object C with a three-dimensional network is completed using the digital UV light printing by the 3D printer according to the present additive manufacturing procedure, in the next step, Step 103, the foaming process, is carried out. This includes: removing the intermediate object C from the 3D printer, placing the intermediate object C in a heating environment, and causing the heat-expendable microcapsules embedded within the substantial parts S of the mesh structure L to undergo thermal expansion, thus enlarging the three-dimensional network of the intermediate object and thereby expanding an overall volume of the three-dimensional network of the intermediate object to ultimately complete the foaming process. For example, the black and white photographs in FIG. 4A and FIG. 4B shows the volume change before and after the foaming process, wherein the intermediate object before the foaming in FIG. 4A and the final product after the foaming in FIG. 4B are shown in the same scale. Under the thermal energy of the foaming process, the intermediate object also undergoes thermal curing, meaning the polymer network formed by UV light polymerization also generates densified polymer bonding due to the thermal effect, further enhancing the mechanical strength of the substantial part of the mesh structure formed by the matrix resin, ultimately forming the additive manufactured resin elastomers. In some embodiments, the thermal curing/expansion step happened in Step 103, and the foaming process comprises a temperature-raising stage, which involves slowly raising the temperature at a rate of 1° C. to 3.5° C. per minute; in some embodiments, the temperature-raising stage includes slowly raising the temperature from the room temperature to the range of 90° C. to 220° C. In some embodiments, the thermal curing/expansion step comprises a constant temperature stage, which includes maintaining the temperature between 90° C. and 220° C. In some embodiments, the duration of the constant temperature stage is preferably 1 hour to 5 hours. In some embodiments, it is possible to heat the intermediate object C at a rate of increasing 1° C. to 3.5° C. per minute. For example, it could involve slowly raising the temperature at a rate of 1° C., 1.2° C., 1.4° C., 1.5° C., 1.6° C., 1.8° C., 2° C., 2.5° C., 3° C., or 3.5° C. per minute. In some embodiments, the constant temperature stage includes maintaining the temperature of the intermediate object C between 90° C. to 220° C., such as, 90° C., 110° C., 115° C., 125° C., 150° C., 165° C., 170° C., 190° C., or 220° C., preferably between 100° C. and 170° C., more preferably between 105° C. and 150° C. In some embodiments, the duration of the constant temperature process is preferably from 1 hour to 5 hours, for example, 1 hour, 2 hours, 3 hours, 4 hours, or 5 hours. In some embodiments, the foaming process of Step 103 includes both the temperature raising stage and the constant temperature stage, and the constant temperature stage is performed after the temperature-raising stage. In some embodiments, the final temperature reached in the temperature-raising stage is equal to the temperatures used in the constant temperature stage. In some embodiments, room temperature includes 20° C. to 30° C., such as 20° C., 22.5° C., 25° C., 27.5° C., or 30° C.

Continuing the explanation of Step 103. In some embodiments, the foaming process of step 103 involves multiple temperature-raising and constant temperature stages. For example, the foaming process may begin with a first temperature-raising stage followed by a first constant temperature stage. After this first constant temperature stage has been maintained for a period of time, it is then followed by a second temperature-raising stage and subsequently a second constant temperature stage. In some embodiments, the foaming process of Step 103 begins by heating the intermediate object C from room temperature to 110° C. over one hour in the first temperature raising stage, followed by maintaining a constant temperature of 110° C. for four hours in the first constant temperature stage. After completing the first temperature-raising stage and the first constant temperature stage, the second temperature-raising stage is initiated. This involves raising the temperature from 110° C. to 140° C. over a period of 30 minutes. Once the temperature reaches 140° C., the second constant temperature stage commences, during which temperature is maintained at 140° C. and the intermediate C is heated continuously for an additional 10 minutes. In some embodiments, the intermediate object C may be heated at a rate of 1° C. to 3.5° C. per minute. Preferably the heating rate is 1° C. to 2° C. per minute; more preferably the rate is 1° C. to 1.6° C. per minute. In some embodiments, the second temperature-raising process has a gentler heating curve than the first, meaning that the temperature increase per minute is less in the second temperature-raising stage. In some embodiments, the duration of the first constant temperature stage is longer than that of the second constant temperature stage.

Continuing the explanation of Step 103, the previously described constant temperature stage and/or the temperature-raising stage help the synchronize the expansion rate of the heat-expendable microcapsules with the thermal curing rate of the surrounding matrix resin, enabling the intermediate object C to achieve full foaming. The term “full foaming” refers to the heat-expandable microcapsules embedded in the substantial part S of the mesh structure L of the intermediate object C with a three-dimensional network being fully expanded. This means that the low-carbon alkanes liquid enclosed within the heat-expandable microcapsules are completely transformed into gas, and due to the volume change from liquid to gas, the outer shell of the heat-expandable microcapsule expands outward, creating multiple closed-cell voids embedded in the substantial parts S. In the situation where the expansion rate of the heat-expendable microcapsules is well-matched with the thermal curing rate of the matrix resin (which forms the substantial parts S of the mesh structure L after UV light photopolymerization) the shell of the fully expanded heat-expandable microcapsule remains intact even when fully expanded. Thus, after completing the foaming process of Step 103, the substantial parts S of the mesh structure L of the three-dimensional network of the foaming additive manufactured resin elastomer is embedded with closed-cell voids, and these closed holes still retain substantially intact outer shells of the heat-expendable microcapsules. The thermal environment in which the intermediate object C is located during the foaming process should be properly regulated to match the expansion rate of the heat-expendable microcapsules with the thermal curing rate of the matrix resin. In some embodiments, Step 103 first involves conducting a temperature-rise stage, followed by a constant temperature stage. During the temperature-rise process, the matrix resin of the substantial part S of the mesh structure L of the intermediate object C undergoes gradual thermal curing due to heating. Simultaneously, the heat-expandable microcapsules embedded in the substantial part S are expanding and foaming as heated. The subsequent constant temperature stage then ensure that the thermal curing reaction of the matrix resin fully completes its effect. Furthermore, in embodiments where Step 103 includes a temperature-raising stage followed by a constant temperature stage, the heat-expandable microcapsules begin to expand and foam during the temperature-raising stage, i.e., the temperature at the end of the temperature-raising stage (and the start of the constant temperature stage) is higher than the foaming initiation temperature of the heat-expandable microcapsule. In another embodiment, Step 103 includes multiple temperature-raising stages and constant temperature stages. For example, Step 103 begins with a first temperature-raising stage followed by a first constant temperature stage, then continues with a second temperature-raising stage and a subsequent second constant temperature stage. In the first temperature-raising stage, the matrix resin of the substantial part S of the mesh structure L of the intermediate object C undergoes uniform thermal curing throughout the entire intermediate object C (e.g., both on the surface and inside of the intermediate object) due to gradual heating, and the subsequent first constant temperature stage ensures that the thermal curing of the matrix resin fully completes its reaction. However, the temperature reached during the first temperature raising stage and the first constant temperature stage do not achieve the foaming initiation temperature required for heat-expandable microcapsules. After completing the first temperature raising stage and the first constant temperature stage, the second temperature raising stage follows, during which the intermediate object is further heated at a temperature that allows the microcapsules to foam, followed by the second constant temperature stage, during which any embedded heat-expandable microcapsules that have not completed expansion and foaming during the second temperature raising stage will finish foaming during in the execution of the second constant temperature stage.

Continuing the explanation of Step 103. Please refer to FIG. 5B, in a thermal environment, the heat-expandable microcapsules, which contain low-carbon alkane liquids, are heated until the liquids transform into gases. This transformation from liquid to gas results in an increase in volume, exerting an impulsive force Fₒᵤₜ, that cause the outer shell of the heat expandable microcapsule to expand outward. Simultaneously, the matrix resin within the same thermal environment undergoes the thermal curing, providing a resisting force Fᵢₙ, against the outward expansion of the shells of the heat-expandable microcapsules. In the situation where Step 103 includes a sequence of a temperature-raising stage followed by a constant temperature stage, the rate of thermal curing of the matrix resin approximately matches the rate of and foaming of the heat-expendable microcapsules. Thus, during the temperature raising stage, the impulsive force Fₒᵤₜ remains roughly equal to the resisting force Fᵢₙ. During the subsequent constant temperature stage, the heat-expandable microcapsules have largely completed their foaming and no longer expand, and the matrix resin does not substantially expand or contract during thermal curing. Therefore, the opposing force Fₒᵤₜ and Fᵢₙ no longer interact during this stage. When Step 103 includes multiple temperature raising stages and constant temperature stages, such as sequentially conducting a first temperature raising stage, a first constant temperature, a second temperature raising stage, and a second constant temperature stage, the first temperature raising stage and the first constant temperature stage do not reach the foaming initiation temperature of heat-expandable microcapsules. Therefore, only the matrix resin undergoes the thermal curing reaction during the first temperature-raising stage and the first constant temperature stage, and the heat-expandable microcapsules begin to foam only during the second temperature raising stage and the second constant temperature stage. Further detailed explanation of the embodiments of Step 103 includes multiple temperature raising stages and constant temperature stages. The first temperature raising stage involves gently raising the temperature to uniformly heat the intermediate object C, preventing uneven heating between the interior and exterior of the intermediate object, which can lead to inconsistent degrees of thermal curing. This is because as the thermal curing reaction begins, the intermediate object C starts to form new cross-links, transitioning from a green stage toward a maturity stage. Since the two stages exhibit different thermal conductivities, if the heating rate of the first temperature raising stage is not properly controlled, the thermal curing reaction of the intermediate object C may be suboptimal. When the first temperature raising stage concludes, heating is maintained at the final reached temperature for a period to carry out the first constant temperature stage. During the first constant temperature stage, the intermediate object C continues to thermally cure until the intermediate object C uniformly approaches the mature stage. Since the matrix resin of the substantial part S of the mesh structure L of the intermediate object C does not substantially expand or shrink during thermal curing, and the operational environment during the first temperature raising stage and the first constant temperature stage does not reach the temperature required to initiate foaming of the heat-expandable microcapsules, the force Fₒᵤₜ and the resisting force Fᵢₙ do not interact during these stages. After completing the first temperature raising stage and the first constant temperature stage, the second temperature raising stage then commences. In this stage, the thermal environment is gradually heated to a temperature that can initiate the foaming of the heat-expandable microcapsules embedded within the matrix resin. After the first temperature raising stage and the first constant temperature stage, the intermediate object C has approached a mature stage of polymerization. By this stage, the intermediate object C has already developed numerous thermal curing bonds, before the start of the second temperature raising stage; i.e., the mechanical properties of the substantial parts S of the mesh structure L in the intermediate object C—which contain embedded heat-expandable microcapsules—are more robust than immediately after production by the 3D printer. Thus, when the second temperature raising stage begins, the matrix resin can provide more sufficient resistance to the expansion of the heat-expandable microcapsules since the impulsive force Fₒᵤₜ exerted by the expansion of the heat-expandable microcapsule and the resisting force Fᵢₙ provided by the matrix resin are opposite action-reaction forces. That is, in the embodiments of including multiple temperature raising stages and constant temperature stages, the impulsive force Fₒᵤₜ and resisting force Fᵢₙ are kept approximately equal. Therefore, throughout the entire process of the foaming and expansion of the heat-expandable microcapsules, the impulsive force Fₒᵤₜ exerted by the expansion of the heat-expandable microcapsules never exceeds the resisting force Fᵢₙ provided by the mechanical strength of the matrix resin. Therefore, the intermediate object C does not suffer mesh structure damage during the foaming process. Last, the second constant temperature stage is conducted to ensure that any heat-expandable microcapsules that have not completely foamed can finish foaming, and to ensure that the intermediate object C can complete its thermal curing.

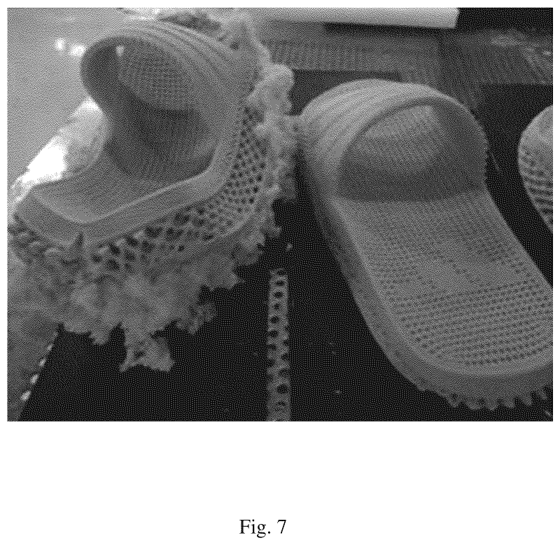

Through the aforementioned process arrangement the intermediate object C produced by the 3D printer can uniformly expand, achieving an increase in volume while maintaining a lattice structure generally identical to that before foaming, as shown in FIG. 6 (right: unfoamed additive manufactured resin elastomer; left: foamed additive manufactured resin elastomer, obtained after Step 103). Conversely, if the foaming process is not properly controlled, it is possible that the curing rate of the matrix resin significantly surpasses the expansion rate of the heat-expandable microcapsule. This leads to the impulsive force Fₒᵤₜ, exerted by the expansion of the heat-expandable microcapsule being insufficient to overcome the resistance from the curing matrix resin, preventing the heat-expandable microcapsule from expanding successfully. As a result, this prevents the intermediate object C from efficiently increasing in volume. Alternatively, if the curing rate of the matrix resin lags far behind the expansion rate of the heat-expandable microcapsule, the impulsive force Fₒᵤₜ, exerted by the expansion of the heat-expandable microcapsule exceeds the resisting force Fᵢₙ provided by the curing matrix resin. In this scenario, the resisting force Fᵢₙ is insufficient to counteract the outward impulsive force Fₒᵤₜ, resulting in the rupture of the microcapsule shells due to the impact of the outward impulsive force from the expansion of the heat-expandable microcapsules. This prevents the volatile liquids within the heat-expandable microcapsule from forming complete closed-cell voids during their transformation to gas, causing the final obtained additive manufactured resin elastomer's lattice structure to burst, as shown in the left side of FIG. 7. After completing Step 103, the formed additive manufactured resin elastomer has a high volume expansion ratio (for example, the volume of the additive manufactured resin elastomer is about 100% to 350% of the volume of the intermediate object C), and the substantial parts S of the three-dimensional network in the additive manufactured resin elastomer contain closed-cell voids. The heat-expandable microcapsule that constitute the closed-cell voids still remain as generally intact shells after foaming. The substantial parts S form the mesh structure L with basic geometric arrangements, which remain generally intact and retain the same shape as before performing Step 103 without deformation due to heating, as shown in the right side of FIG. 7.

The present disclosure also provides an additive manufactured resin elastomer formed by the aforementioned method. The characteristics of the foaming dual-curing resin composition 205 used for producing the additive manufactured resin elastomer can be referenced from the descriptions mentioned previously. The additive manufactured resin elastomer comprises the substantial parts S, which are formed by cross-linking bonds between macro- and micro-molecules contained in the matrix resin, and voids embedded within these substantial parts, created from the expansion of the heat-expandable microcapsules. The substantial parts S form a spatial arrangement characterized by basic geometric configurations. This arrangement establishes a mesh structure L, which themselves are composed of these geometrically arranged solid parts S. These interconnected mesh structures L collectively constitute a three-dimensional network. The shape of the void is generally circular, such as round, oval, or ovate, because they are closed-cell voids formed by the generally intact shells of the heat-expandable microcapsules. The three-dimensional network structure is produced through an additive manufacturing method, and the specific steps can be referenced in the previous descriptions regarding Step 102. The overall density of the additive manufactured resin elastomer ranges from 100 kg/m³ to 1,000 kg/m³. For example, 100 kg/m³, 500 kg/m³, 600 kg/m³, 700 kg/m³, 800 kg/m³, 900 kg/m³, or 1,000 kg/m³. In some embodiments, the additive manufactured resin elastomer includes multiple sections that are continuously distributed from one side to the opposite side. In some embodiments, the direction extending from the one side over to the opposite side is substantially parallel to the aforementioned pulling direction D. Additionally, the difference in density between each of these sections of the additive manufactured resin elastomer compared to the average density of the additive manufactured resin elastomer is less than 80 kg/m³ and larger than 0 kg/m³. This implies that the density of the three-dimensional network within the additive manufactured resin elastomer is sufficiently uniform. In some embodiments, the absolute value of the density gradient within the additive manufactured resin elastomer is less than 50 kg/(m³*cm) and larger than 0 kg/(m³*cm). This density gradient refers to the density change in density per centimeter along the linear distance from the one side to the opposite side of the additive manufactured resin elastomer. In other words, the density variations of the matrix resin in the additive manufactured resin elastomer are sufficiently subtle without excessive changes. In some embodiments, the standard deviation of density within the additive manufactured resin elastomer is less than 32 kg/m³ and larger than kg/m³, ensuring sufficient uniformity in density and good mechanical properties.

Continuing the explanation of the additive manufactured resin elastomer, after the additive manufactured resin elastomer undergoes the dual-curing process, which is the photopolymerization process recited in Step 102 and the thermal curing process recited in Step 103, the components of the original foaming dual-curing resin composition achieve complete cross-linking, resulting in the final additive manufactured resin elastomer having fully developed mechanical properties, such as compressive strength, torsional stiffness, shear strength, impact resistance, tensile strength, elongation at break, and (trouser) tear strength, etc. For example, the tensile strength of the additive manufactured resin elastomer ranges from 3 MPa to 17 MPa, such as 3 MPa, 5 MPa, 7 MPa, 9 MPa, 11 MPa, 13 MPa, 15 MPa, or 17 MPa; elongation at break ranges from 120% to 340%, for example, 120%, 140%, 180%, 220%, 260%, 300%, or 340%; and (trouser) tear strength ranges from 2 N/mm to 9 N/mm, for example, 2 N/mm, 3 N/mm, 4 N/mm, 5 N/mm, 6 N/mm, 7 N/mm, 8 N/mm, or 9 N/mm.

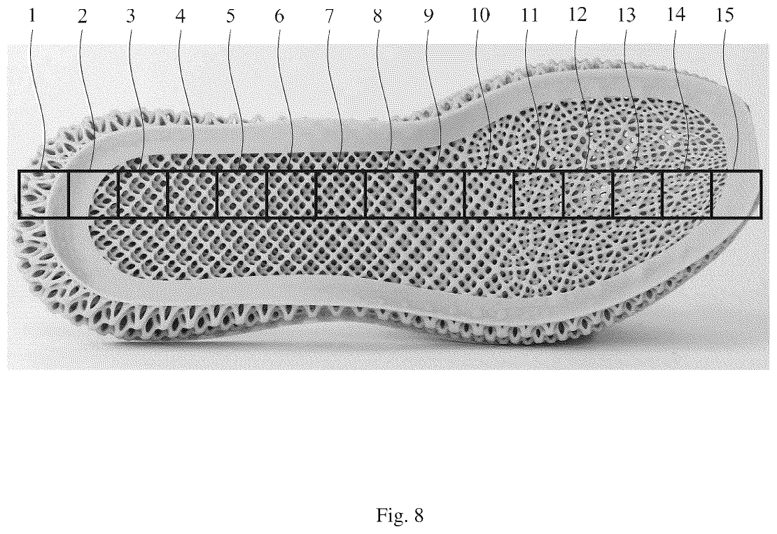

Continuing the explanation of the additive manufactured resin elastomer, in some embodiments, the additive manufactured resin elastomer may have the shape of the shoe midsole shown in FIG. 8. In these embodiments, during the formation of the intermediate object C, the printing direction (with respect to the pulling direction D) is substantially parallel to the direction from the toe to the heel. In these embodiments, the three-dimensional network of the additive manufactured resin elastomer has a first density in the toe box part, a second density at the heel part, and a third density in between the toe and the heel parts, where the first density is greater than the second density, and both the first density and the second density are greater than the third density.

Next, a detailed explanation of the density distribution and variation in the shoe sole as shown in FIG. 8 will be provided. The following embodiments are used to help those skilled in the art to better understand the present disclosure described in the patent specification and are not intended to limit the scope and appended claims of the present disclosure.

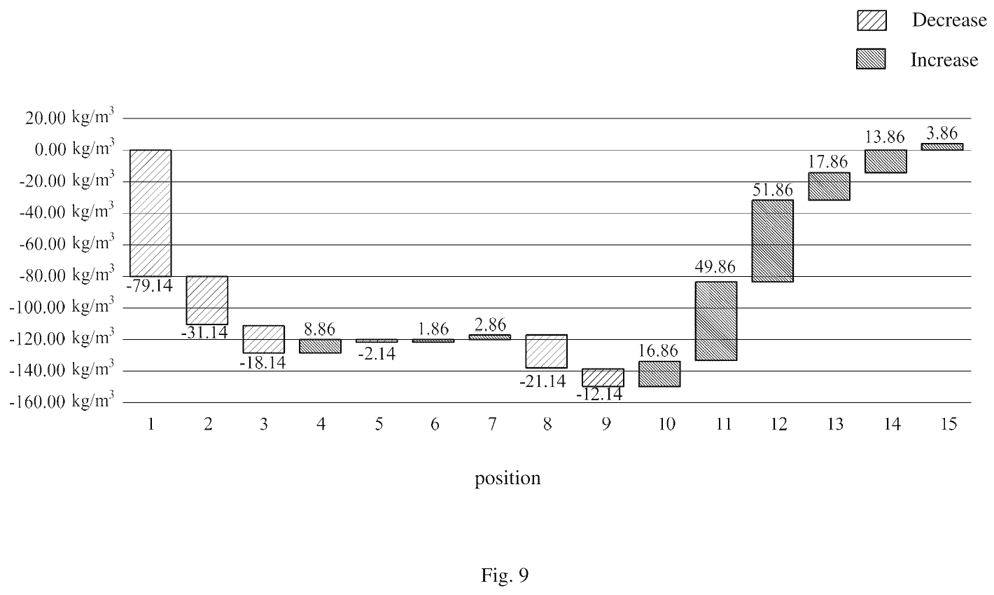

As shown in FIG. 8, the average density of the shoe sole is about 817.14 kg/m³. Referring to Table 1 and Table 2, the shoe sole as shown in FIG. 8 is divided equally into 15 segments from the heel to the toe and are sequentially labeled as position 1 to position 15. The density at each position from position 1 to position 15 along with the density difference from the average at each position, are shown in Table 1. The density changes between adjacent positions (e.g., position 1 to position 2, position 2 to position 3, and so on) are shown by the density gradients in Table 2. FIG. 9 is the waterfall plot of the density variation along positions in the shoe sole as shown in FIG. 8, where the X-axis sequentially marks each position and the corresponding difference from the average density, and the Y-axis is in unites of kg/m³. The shoe sole as shown in FIG. 8 has sufficient uniformity in its three-dimensional network as described.

TABLE 1

| | Density | Difference from the average |
|---|---|---|
| Position | (kg/m³) | density (kg/m³) |
| 1 | 738 | −79.14 |
| 2 | 786 | −31.14 |
| 3 | 799 | −18.14 |
| 4 | 826 | 8.86 |
| 5 | 815 | −2.14 |
| 6 | 819 | 1.86 |
| 7 | 820 | 2.86 |
| 8 | 796 | −21.14 |
| 9 | 805 | −12.14 |
| 10 | 834 | 16.86 |
| 11 | 867 | 49.86 |
| 12 | 869 | 51.86 |
| 13 | 835 | 17.86 |
| 14 | 831 | 13.86 |
| 15 | 821 | 3.86 |

TABLE 2

| | Density gradient |
|---|---|
| | (kg/(m³*cm)) |
| Position 1 to Position 2 | 48.00 |
| Position 2 to Position 3 | 13.00 |
| Position 3 to Position 4 | 27.00 |
| Position 4 to Position 5 | −11.00 |
| Position 5 to Position 6 | 4.00 |
| Position 6 to Position 7 | 1.00 |
| Position 7 to Position 8 | −24.00 |
| Position 8 to Position 9 | 9.00 |
| Position 9 to Position 10 | 29.00 |
| Position 10 to Position 11 | 33.00 |
| Position 11 to Position 12 | 2.00 |
| Position 12 to Position 13 | −34.00 |
| Position 13 to Position 14 | −4.00 |
| Position 14 to Position 15 | −10.00 |

Continuing the explanation of the additive manufactured resin elastomer, embodiment 1-1 to embodiment 1-5 in Table 3, embodiment 2-1 to embodiment 2-5 in Table 4, and embodiment 3-1 to embodiment 3-5 in Table 5 are used to demonstrate that the additive manufactured resin elastomer produced by the method of the present disclosure exhibits good volume expansion ratio, tensile strength, elongation at break, and (trouser) tear strength. The foaming dual-curing resin composition used in these embodiment, as shown in Table 3, Table 4, and Table 5, are all produced by TPK Electronic Materials Co., Ltd., but the different models are selected according to the needed performance of different products. In Table 3, embodiment 1-1 to embodiment 1-5 all use the same foaming dual-curing resin composition. However, during the foaming process, variations may occur in the temperature raising stage, such as the target temperature reached from room temperature, the time required for heating, and the heating rate. Similarly, differences in the set temperature and the duration of the constant temperature stage may also occur, see Table 3 for details. Similarly, in Table 4, embodiment 2-1 to embodiment 2-5 all use the same foaming dual-curing resin composition. However, during the foaming process, variations may occur in the temperature raising stage, such as the target temperature reached from room temperature, the time required for heating, and the heating rate. Similarly, difference in the set temperature and the duration of the constant temperature stage may also occur, see Table 4 for details. In Table 5, embodiment 3-1 to embodiment 3-5 all use the same foaming dual-curing resin composition. However, during the foaming process, variances may occur in the temperature raising stage, such as the target temperature reached from room temperature, the time required for heating, and the heating rate. Similarly, differences in the set temperature and the duration of the constant temperature stage may also occur, see Table 5 for details.

TABLE 3

| | Temperature | constant | | | | |
|---|---|---|---|---|---|---|
| | raising stage | temperature | | | | (Trouser) |
| | (temperature | stage | Volume | Tensile | Elongation | tear |
| | reached, time | (temperature, | expansion | strength | at break | strength. |
| | needed, ramp rate) | duration) | ratio (%) | (MPa) | (%) | (N/mm) |
| Embodiment | 105° C., | 105° C., | 303.74 | 3.32 | 202.1 | 3.49 |
| 1-1 | 30 min, | 2 hr | | | | |
| | ~2.66° C./min | | | | | |
| Embodiment | 110° C., | 110° C., | 324.40 | 3.14 | 189.3 | 3.59 |
| 1-2 | 30 min, | 1.5 hr | | | | |
| | ~2.83° C./min | | | | | |
| Embodiment | 110° C., | 110° C., | 256.60 | 3.85 | 255.5 | 4.17 |
| 1-3 | 30 min, | 2 hr | | | | |
| | ~2.83° C./min | | | | | |
| Embodiment | 110° C., | 110° C., | 221.50 | 3.56 | 202.2 | 4.13 |
| 1-4 | 30 min, | 2.5 hr | | | | |
| | ~2.83° C./min | | | | | |
| Embodiment | 115° C., | 115° C., | 258.43 | 4.44 | 223.9 | 3.45 |
| 1-5 | 30 min, | 2 hr | | | | |
| | ~3° C./min | | | | | |

TABLE 4

| | Temperature | constant | | | | |
|---|---|---|---|---|---|---|
| | raising stage | temperature | | | | (Trouser) |
| | (temperature | stage | Volume | Tensile | Elongation | tear |
| | reached, time | (temperature, | expansion | strength | at break | strength. |
| | needed, ramp rate) | duration) | ratio (%) | (MPa) | (%) | (N/mm) |
| Embodiment | 105° C., | 105° C., | 178.70 | 7.55 | 133.1 | 2.65 |
| 2-1 | 30 min, | 2 hr | | | | |
| | ~2.66° C./min | | | | | |
| Embodiment | 110° C., | 110° C., | 176.81 | 7.78 | 127.6 | 2.63 |
| 2-2 | 30 min, | 1.5 hr | | | | |
| | ~2.83° C./min | | | | | |
| Embodiment | 110° C., | 110° C., | 155.15 | 8.73 | 140.7 | 2.79 |
| 2-3 | 30 min, | 2 hr | | | | |
| | ~2.83° C./min | | | | | |
| Embodiment | 110° C., | 110° C., | 158.18 | 9.19 | 143.1 | 3.05 |
| 2-4 | 30 min, | 2.5 hr | | | | |
| | ~2.83° C./min | | | | | |
| Embodiment | 115° C., | 115° C., | 160.60 | 8.07 | 134.9 | 2.8 |
| 2-5 | 30 min, | 2 hr | | | | |
| | ~3° C./min | | | | | |

TABLE 5

| | Temperature- | constant | | | | |
|---|---|---|---|---|---|---|
| | raising | temperature | | | | (Trouser) |
| | stage(temperature | stage | Volume | Tensile | Elongation | tear |
| | reached, time | (temperature, | expansion | strength | at break | strength. |
| | needed, ramp rate) | duration) | ratio (%) | (MPa) | (%) | (N/mm) |
| Embodiment | 105° C., | 105° C., | 176.32 | 7.97 | 140.2 | 2.74 |
| 3-1 | 30 min, | 2 hr | | | | |
| | ~2.66° C./min | | | | | |
| Embodiment | 110° C., | 110° C., | 176.32 | 7.73 | 151.3 | 2.79 |
| 3-2 | 30 min, | 1.5 hr | | | | |
| | ~2.83° C./min | | | | | |
| Embodiment | 110° C., | 110° C., | 153.50 | 7.68 | 160.3 | 2.96 |
| 3-3 | 30 min, | 2 hr | | | | |
| | ~2.83° C./min | | | | | |
| Embodiment | 110° C., | 110° C., | 148.94 | 8.79 | 174.9 | 3.17 |
| 3-4 | 30 min, | 2.5 hr | | | | |
| | ~2.83° C./min | | | | | |
| Embodiment | 115° C., | 115° C., | 179.25 | 9.27 | 182.1 | 3.28 |
| 3-5 | 30 min, | 2 hr | | | | |
| | ~3° C./min | | | | | |

Next, comparative examples in Table 6 illustrate that when the additive manufactured resin elastomer is produced by methods other than the method of the present disclosure, the final foamed product may have uneven foamed output, resulting in the shape of the final foamed product being different from that of the object prior to the foaming process, or causing the final foamed product to burst due to excessive foaming. In comparative example 1 to comparative example 6 in Table 6, the solidified objects formed in the additive manufacturing process are a cube of 30 cm*30 cm*30 cm; the solidified objects undergo the foaming under the heating condition 1, the heating condition 2, and the heating condition 3 as listed in Table 6 in the given sequence. Since the comparative examples did not undergo the foaming process of the present disclosure (for example, a process without a gradual temperature raising stage), the foamed products of comparative example 1 and comparative example 2 are deformed, not retaining their original shape before foaming. The structures of the foamed products of the comparative example 3, 4, 5, and 6 even show a structure that burst (as shown in left side of FIG. 7).

TABLE 6

| | Heating | Heating | Heating | |
|---|---|---|---|---|
| | condition 1 | condition 2 | condition 3 | |
| | (isothermal | (isothermal | (isothermal | |
| | temperature, | temperature, | temperature, | Appearance after |
| | duration) | duration) | duration) | foaming reactions |
| Comparative | 115° C., | 140° C., | 115° C., | Uneven foaming result, |
| example 1 | 30 min | 20 min | 5 hr | deformed final product |
| | | | | after foaming |
| Comparative | 115° C., | 140° C., | 115° C., | Uneven foaming result, |
| example 2 | 30 min | 20 min | 5 hr | deformed final product |
| | | | | after foaming |
| Comparative | 115° C., | 160° C., | 115° C., | Over-foaming |
| example 3 | 30 min | 20 min | 5 hr | reactions, explosion- |
| | | | | damaged final product |
| | | | | after foaming |
| Comparative | 115° C., | 160° C., | 115° C., | Over-foaming |
| example 4 | 30 min | 20 min | 5 hr | reactions, explosion- |
| | | | | damaged final product |
| | | | | after foaming |
| Comparative | 115° C., | 170° C., | 115° C., | Over-foaming |
| example 5 | 30 min | 20 min | 5 hr | reactions, burst final |
| | | | | product after foaming |
| Comparative | 115° C., | 170° C., | 115° C., | Over-foaming |
| example 6 | 30 min | 20 min | 5 hr | reactions, burst final |
| | | | | product after foaming |

The additive manufactured resin elastomer formed by the method of the present disclosure has a high volume expansion ratio, and the foaming process does not cause deformation of the originally defined three-dimensional network of the additive manufacturing. That is, the final additive manufactured resin elastomer maintains an intact mesh structure and retains generally the same shape as before foaming. After foaming, the final additive manufactured resin elastomer exhibits a sufficiently uniform density, and the substantial parts of the three-dimensional network structure are fully cured to achieve the expected mechanical properties of the three-dimensional network, such as fully developed compressive strength, torsional stiffness, shear strength, impact resistance, tensile strength, elongation at break, and (trouser) tear strength.

Although the present disclosure has been described in considerable detail with reference to certain embodiments thereof, other embodiments are possible. Therefore, the spirit and scope of the appended claims should not be limited to the description of the embodiments contained herein. It would be apparent to those skilled in the art that various modifications and variations can be made to the structure without departing from the scope or spirit of the disclosure. In view of the foregoing, it is intended that the present disclosure cover modifications and variations of this disclosure provided they fall within the scope of the following claims.

### COMPONENT SYMBOL

1˜15: Position
100: Method
101˜103: Step
201: Digital UV light
202: Digital UV irradiation range
2021: Digital UV focused irradiation area
2022: Digital UV non-focused irradiation area
205: Foaming dual-curing resin composition
206: Resin tank
207: Carrier platform
C: Intermediate object
D: Pulling direction
L: Mesh structure
S, S′, S″: Substantial part
B: Heat-expandable microcapsule
Fᵢₙ: Resisting force
Fₒᵤₜ: Impulsive force

What is claimed is:

1. A method of manufacturing a foaming dual-curing resin composition through additive manufacturing comprising the following operations:
a resin providing process, comprising:
providing the foaming dual-curing resin composition suitable for additive manufacturing, the foaming dual-curing resin composition comprising a matrix resin and heat-expandable microcapsules;
an additive manufacturing process, comprising:
placing the foaming dual-curing resin composition in a printer of continuous liquid interface production, and subjecting the foaming dual-curing resin composition to ultraviolet (UV) irradiation, thereby undergoing a photopolymerization reaction to form a substantial part, which defines a plurality of mesh structures, wherein
the plurality of mesh structures collectively form a three-dimensional network structure that constitutes an intermediate object; and
heat-expandable microcapsules mixed within the foaming dual-curing resin composition are embedded in the substantial part of the plurality of mesh structures of the intermediate object during the photopolymerization reaction; and
a foaming process comprising:
removing the intermediate object manufactured from the continuous liquid interface production from the printer and placing the intermediate object in a thermal environment so that the heat-expandable microcapsules embedded in the substantial part are heated and expand, enlarging the three-dimensional network structure of the intermediate object, and the intermediate object is thermally cured in the thermal environment and forms an additive manufactured resin elastomer.

2. The method of claim 2, wherein a density difference between the matrix resin and the heat-expandable microcapsules in the foaming dual-curing resin composition is less than 1 g/mL and larger than or equal to 0 g/mL.

3. The method of claim 1, wherein the heat-expandable microcapsules do not react to the UV irradiation.

4. The method of claim 1, wherein the foaming process comprises a temperature raising stage and a constant temperature stage; wherein the temperature raising stage increases a temperature from room temperature to a final temperature range of 90° C. to 220° C. at a rate of 1° C. to 3.5° C. per minute; and the constant temperature stage maintains a final temperature achieved in the temperature raising stage for 1 hour to 5 hours.

5. The method of claim 1, wherein the foaming process comprises:
a first temperature raising stage, a first constant temperature stage, a second temperature raising stage, and a second constant temperature stage; wherein
the first temperature raising stage comprises heating from room temperature to a first temperature of 100° C. to 120° C. over a period of 0.75 hours to 1.25 hours;
the first constant temperature stage comprises maintaining the first temperature for 3.5 hours to 4.5 hours;
the second temperature raising stage comprises heating the first temperature to a second temperature of 130° C. to 150° C. over 20 minutes to 40 minutes; and
the second constant temperature comprises maintaining the second temperature for 5 minutes to 15 minutes.

6. The method of claim 1, wherein the foaming process is carried out at standard atmosphere.

7. An additive manufactured resin elastomer produced by the method of claim 1, comprising:
an additive manufactured three-dimensional network, which is constituted by interconnection of the plurality of mesh structures; each of which comprises a spatial arrangement of basic geometric configuration; and the additive manufactured three-dimensional network constituting the additive manufactured resin elastomer; and
a plurality of voids embedded in the substantial part of the plurality of mesh structure; and,
the additive manufactured resin elastomer having a density gradient, which has an absolute value of a first direction, an absolute value of a second direction, and an absolute value of a third direction that are less than 50 kg/(m³*cm) respectively; and
the first direction, the second direction, and the third direction are perpendicular to each other.

8. The additive manufactured resin elastomer of claim 7, wherein the plurality of voids are closed-cell voids.

9. The additive manufactured resin elastomer of claim 7, wherein the plurality of voids cause a volume of the additive manufactured resin elastomer to expand by 100% to 350% of a volume of the additive manufactured resin elastomer before foaming.
